(19) United States
(12) Patent Application Publication
(10) Pub. No.: US 2018/0222427 A1
(43) Pub. Date: Aug. 9, 2018

(54) SIDE AIRBAG DEVICE

(71) Applicant: TS TECH CO., LTD., Asaka-shi, Saitama (JP)

(72) Inventors: Jinichi Tanabe, Tochigi (JP); Tatsuo Sayama, Tochigi (JP); Hidetsune Nonaka, Tochigi (JP)

(21) Appl. No.: 15/749,345

(22) PCT Filed: Jul. 29, 2016
(86) PCT No.: PCT/JP2016/072369

§ 371 Date: Jan. 31, 2018

(30) Foreign Application Priority Data
Aug. 6, 2015 (JP) 2015-156322

(51) Int. Cl. B60R 21/207; B60R 21/217

(52) U.S. Cl. CPC B60R 21/207; B60R 2021/0006; B60R 21/217

(57) ABSTRACT

A side airbag device, provided between a vehicle body and rear seat, includes: a base member having upper and lower base attachment portions, attached to portions of the vehicle body, and a base storage portion that stores an airbag and inflator and is interposed between the base attachment portions in an up to down direction; and a retainer member adapted to hold the base storage portion from the vehicle body rear side. Upper and lower engagement recessed portions located at the retainer member center in the vehicle body width direction are arranged in the up to down direction to be engaged with engagement protruded portions provided at the vehicle body, which is located on the rear side. The base attachment portions are configured so that an imaginary surface passes them and extends in the front to back direction of the vehicle body to pass the upper engagement recessed portion.

### CROSS REFERENCE TO RELATED APPLICATIONS

This application is a National Stage Entry application of PCT Application No. PCT/JP2016/072369, filed Jul. 29, 2016, which claims the priority benefit of Japanese Patent Application No. JP 2015-156322, filed Aug. 6, 2015, the contents being incorporated herein by reference.

### BACKGROUND

The present disclosure relates to a side airbag device for cushioning an impact applied from the side of a vehicle body and particularly pertains to a side airbag device arranged between the vehicle body and a rear seat.

An example side airbag device includes an inflator configured to inject gas to the inside of an airbag, a box-shaped storage box configured to store the airbag and the inflator, and a resin base cover adapted to cover the storage box from the front side of a vehicle body, and has been conventionally known as a side airbag device arranged between a vehicle body door and a rear seat in the vehicle body width direction (for example, see Japanese Patent Publication JP 2009-040328 A).

The side airbag device described in Japanese Patent Publication JP 2009-040328 A is configured so that the airbag stored in the metal storage box is inflated by the inflator and thereby breaks a small-thickness portion of the resin base cover located on the vehicle body front side of the airbag to be inflated and deployed. Specifically, when an impact equal to or larger than a predetermined value is applied from the side of the vehicle body, the impact is detected by an impact sensor (not shown) and electric power for ignition is supplied to the inflator; therefore, the airbag is inflated and deployed on the side of a seated occupant.

However, in the side airbag device as described in Japanese Patent Publication JP 2009-040328 A, when the inflator is operated to inflate the airbag, gas pressure from the inflator, which inflates the airbag, may put a significant load on the storage box. Therefore, a technique to enable the surroundings of the storage box storing the airbag and the inflator to have the improved rigidity at the time of inflation and deployment of the airbag has been required. Particularly, in the foregoing airbag device, the storage box of the side airbag device is made of metal in order to improve the strength. For the purpose of weight reduction, it is desirable to change the metal storage box to a resin storage box. However, even in a case where the metal storage box is changed to the resin storage box, suitable techniques to enable the resin storage box to have improved rigidity at the time of inflation and deployment of the airbag are desirable.

### SUMMARY

The present disclosure is made in view of the foregoing problem, and thus an embodiment of the present disclosure provides a side airbag device in which the surroundings of a storage box storing an airbag and an inflator has improved rigidity at the time of inflation and deployment of the airbag. Also, an embodiment of the present disclosure provides a side airbag device that can achieve weight reduction.

The foregoing problem is solved by an embodiment of a side airbag device according to the present disclosure. The side airbag device provided between a vehicle body and a rear seat includes: an inflatable airbag; an inflator configured to supply gas to the inside of the airbag; a base member including a base storage portion configured to store the airbag in a folded state and the inflator and being placed between a vehicle body door and the rear seat; and a retainer member adapted to hold the base storage portion from a rear side of the vehicle body. Upper and lower engagement portions that are spaced from each other in the up to down direction and that protrude toward a portion of the vehicle body, which is located on the rear side of the vehicle body, are provided at a center of the retainer member in the vehicle body width direction. The upper and lower engagement portions are engaged with engaged portions provided at the portions of the vehicle body.

As described above, the upper and lower engagement portions are provided at the center of the retainer member in the vehicle body width direction. The upper and lower engagement portions are spaced apart from each other in the up to down direction while protruding toward the portion of the vehicle body, which is located on the rear side of the vehicle body, and the upper and lower engagement protruded portions are engaged with the engaged portions provided at the portions of the vehicle body. Thus, mounting rigidity of the retainer member holding the base storage portion is improved. As a result, the surroundings of the base storage portion has the improved rigidity at the time of inflation and deployment of the airbag and therefore the inflation and deployment direction of the airbag can be further stabilized. Also, the work to mount the entire side airbag device including the retainer member to the vehicle body is facilitated.

In such a case, the retainer member may include: a rear wall portion arranged on the vehicle body rear side of the base storage portion; and right and left sidewall portions that extend from opposite ends of the rear wall portion in the vehicle body width direction toward a front side of the vehicle body. Portions of the rear wall portion may be cut and raised to form the engagement portions, and one of an engagement protruded portion and an engagement recessed portion that serve as the engagement portions may be engaged in the up to down direction with the other of the engagement protruded portion and the engagement recessed portion that serve as the engaged portions. As described above, portions of the retainer member are cut and raised to form the engagement portions; therefore, compared with a case where engagement portions are separately placed to be formed on the rear wall, the weight of the retainer member can be reduced. Also, the engagement portions are provided on the rear wall portion, and one of the engagement protruded portion and the engagement recessed portion that serve as the engagement portions is engaged in the up to down direction with the other of the engagement protruded portion and the engagement recessed portion that serve as the engaged portions. Therefore, the work to mount the retainer member to the vehicle body is further facilitated.

In such a case, the base member may include upper and lower base attachment portions positioned so that the base storage portion is interposed between the upper and lower base attachment portions in the up to down direction, and the upper and lower base attachment portions may be attached to a portion of the vehicle body. The upper and lower engagement portions are configured so that an imaginary surface passing the upper and lower base attachment portions and extending in the front to back direction of the vehicle body passes at least one of the upper and lower engagement portions. As described above, the upper and lower base attachment portions and the upper and lower engagement portions of the retainer member are provided in consideration of the arrangement of the base storage portion that particularly requires rigidity in the base member; therefore, the rigidity of the base storage portion is further improved. As a result, the surroundings of the base storage portion can have the improved rigidity and the inflation and deployment direction of the airbag can be further stabilized.

In such a case, each of the engagement portions may be the engagement recessed portion, and the engagement portion may include: right and left engagement sidewall portions spaced apart from each other in the vehicle body width direction and extending from the rear wall portion toward the rear side of the vehicle body; and an engagement rear wall portion connecting extending portions of the right and left engagement sidewall portions. An engagement opening portion through which the engagement protruded portion extends into a space surrounded by the right and left engagement sidewall portions and the engagement rear wall portion may be formed in a lower end of the engagement portion. Also, an engagement upper wall portion extending from the rear wall portion toward the rear side of the vehicle body and connected to upper ends of the right and left engagement sidewall portions and an upper end of the engagement rear wall portion, may be provided at at least one of the upper and lower engagement portions. The engagement portion is formed as described above; thereby, the rigidity of the retainer member itself can be secured, and in addition, the entire side airbag device including the retainer member can be stably attached to the vehicle body.

In such a case, each of the engagement portions may be the engagement protruded portion, and the engagement portion may include: right and left engagement sidewall portions spaced apart from each other in the vehicle body width direction and extending from the rear wall portion toward the rear side of the vehicle body; and an engagement rear wall portion connecting extending portions of the right and left engagement sidewall portions and partially protruding downward from the engagement sidewall portions. The protruding portion of the engagement rear wall portion may be engaged with an engagement recessed portion provided in a portion of the vehicle body. The engagement portion is formed as described above; thereby, the rigidity of the retainer member itself can be secured, and in addition, the entire side airbag device including the retainer member can be stably attached to the vehicle body.

In such a case, respective holes through which a mounting shaft provided on the inflator extends may be formed in the base storage portion and the retainer member to communicate with each other. A mounting member may be mounted to the mounting shaft from one side of the hole, which is opposite from the other side of the hole, which is located adjacent to the inflator, and the mounting shaft may be mounted on one of the sidewall portions of the retainer member. According to the above configuration, the mounting shaft of the inflator is mounted on one of the sidewall portions of the base storage portion and the retainer member; therefore, compared with a case where the mounting shaft is conventionally mounted on the rear wall portions of the base storage portion and the retainer member, downsizing in the front to back direction of the vehicle body can be achieved. Also, in the present disclosure, the retainer member is configured to be engaged with portions of the vehicle body in the front to back direction of the vehicle body; therefore, interference with the portions of the vehicle body is easily inhibited.

According to the present disclosure, the upper and lower engagement portions engaged with the engaged portions provided at portions of the vehicle body are provided at the center of the retainer member in the vehicle body width direction. Therefore, mounting rigidity of the retainer member holding the base storage portion is improved. As a result, the surroundings of the base storage portion can have the improved rigidity at the time of inflation and deployment of the airbag and therefore the inflation and deployment direction of the airbag can be further stabilized. Also, the work to mount the entire side airbag device including the retainer member to the vehicle body is facilitated. Further, according to the present disclosure, the weight of the retainer can be reduced. Also, the work to mount the retainer member to the vehicle body is further facilitated.

According to the present disclosure, the rigidity of the base storage portion is further improved. As a result, the surroundings of the base storage portion can have the improved rigidity and the inflation and deployment direction of the airbag can be further stabilized. Further, according to the present disclosure, the engagement portion is configured as described above; thereby, the rigidity of the retainer member itself can be secured, and in addition, the entire side airbag device including the retainer member can be stably attached to the vehicle body. Furthermore, according to the present disclosure, downsizing in the front to back direction of the vehicle body can be achieved. Also, interference with the portions of the vehicle body is easily inhibited.

### BRIEF DESCRIPTION OF DRAWINGS

Various embodiments of the invention are illustrated in the drawings, in which:

FIG. 1 is a perspective diagram showing the arrangement of a side airbag device according to an embodiment of the present disclosure;

FIG. 2 is a perspective view of a base member of the side airbag device as viewed from the front side;

FIG. 3 is a perspective view of the base member as viewed from the back side;

FIG. 4 is an exploded perspective view illustrating a structure for mounting an inflator, the base member, and a retainer member;

FIG. 5 is an exploded perspective view illustrating the structure for mounting the retainer member and a vehicle body member;

FIG. 6 is an end view showing the structure for mounting the retainer member and the vehicle body member;

FIG. 7 is a rear view of the side airbag device;

FIG. 8 is a cross-sectional view taken along the line A-A of FIG. 1 and showing a state where an airbag is stored;

FIG. 9 is a cross-sectional view taken along the line A-A of FIG. 1 and showing a state where the airbag is inflated;

FIG. 10 is a rear view showing a modified example of the retainer member; and

FIG. 11 is a perspective view showing another modified example of the retainer member.

### DETAILED DESCRIPTION

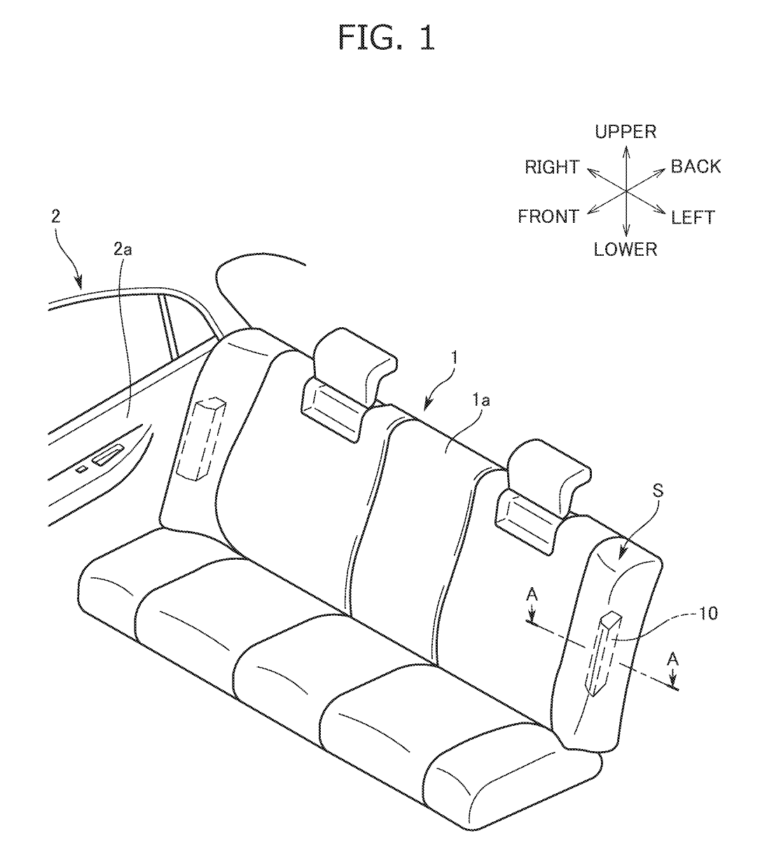

Hereinafter, a side airbag device according to various embodiments of the present disclosure is described with reference to FIG. 1 to FIG. 11. Various embodiments relate to a side airbag device provided between a vehicle body and a rear seat, the side airbag device including: a base member which includes a base storage portion configured to store an airbag and an inflator, and upper and lower base attachment portions which are positioned so that the base storage portion is interposed between the upper and lower base attachment portions in the up to down direction and which are attached to portions of the vehicle body; and a retainer member adapted to hold the base storage portion from the rear side of the vehicle body. Upper and lower engagement recessed portions located at the center of the retainer member in the vehicle body width direction are arranged to be engaged in the up to down direction with engagement protruded portions provided at a portion of the vehicle body, which is located on the rear side of the vehicle body. Further, the upper and lower base attachment portions are configured so that an imaginary surface passing the upper and lower base attachment portions and extending in the front to back direction of the vehicle body passes the upper engagement recessed portion.

A side airbag device S of the present embodiment is configured to cushion an impact applied to a seated occupant from the side of a vehicle body, and as shown in FIG. 1, the side airbag device S is arranged between a seat back 1a as a backrest of a rear seat 1 and a vehicle body door 2a of a vehicle body 2 in the vehicle body width direction. In addition, the single side airbag device S is arranged at each one of the right and left outer sides of the rear seat 1 in the vehicle body width direction.

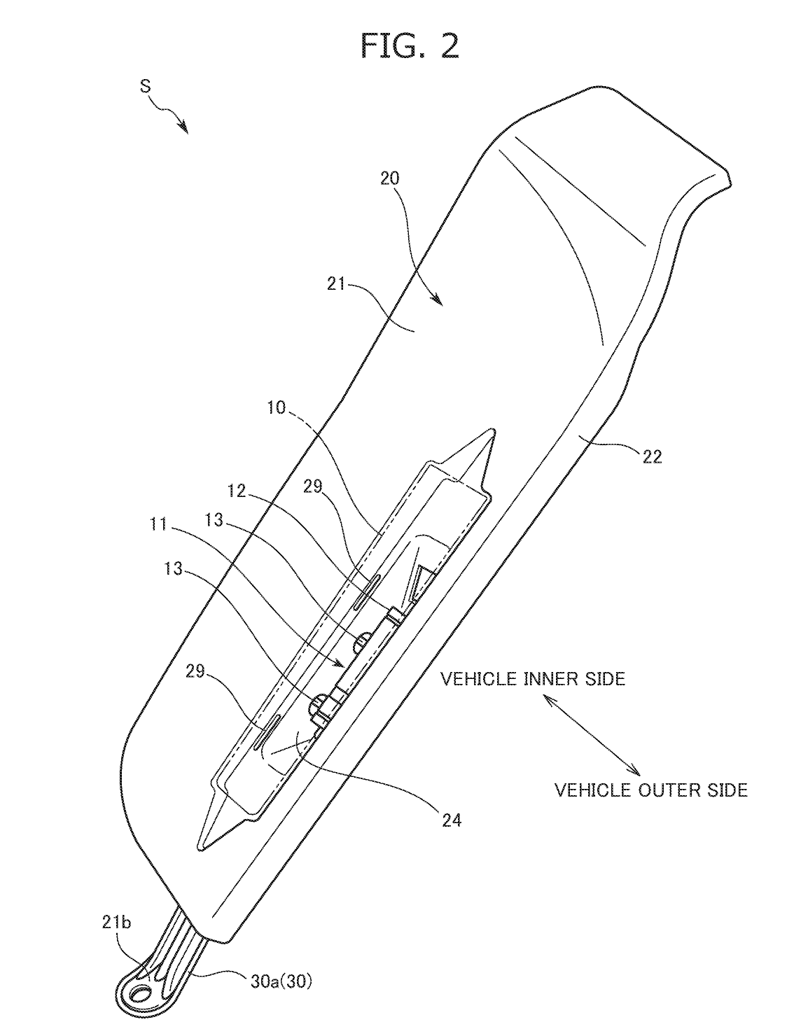

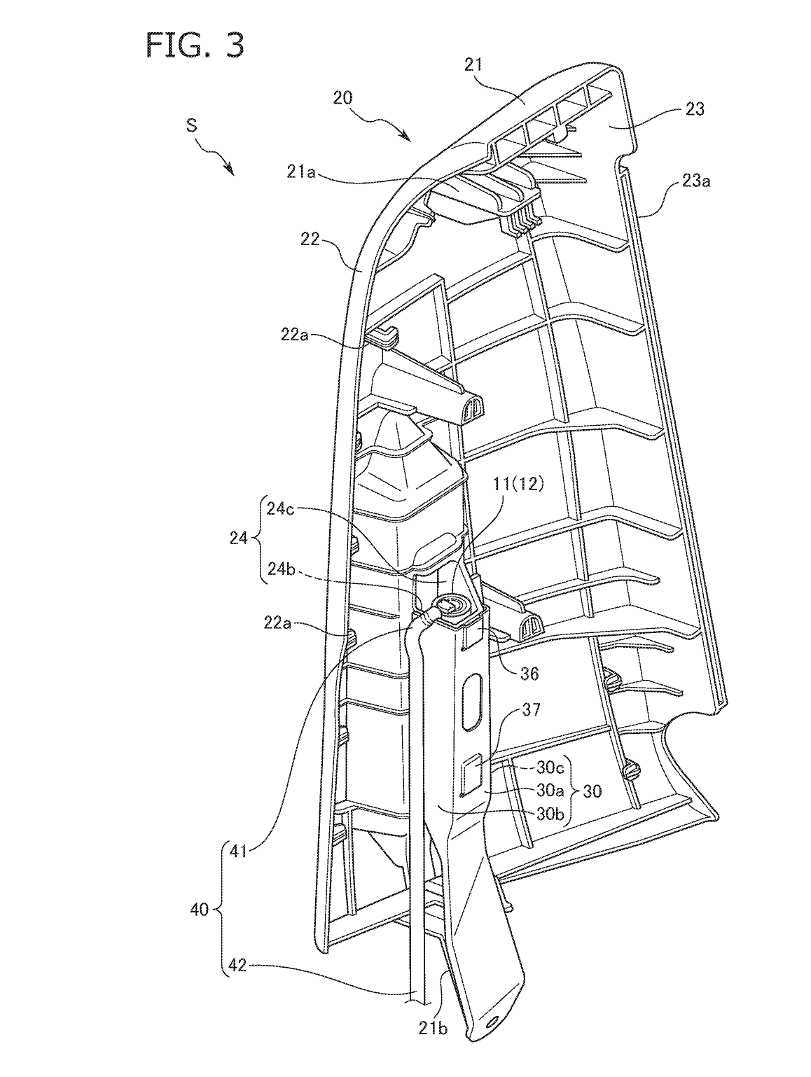

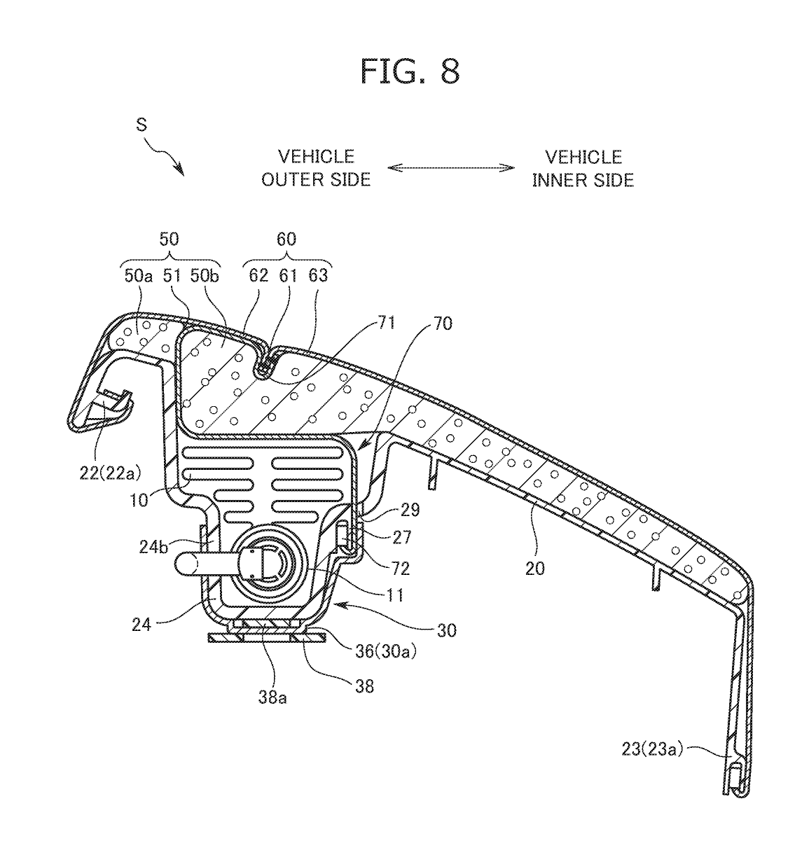

As shown in FIG. 2, the side airbag device S mainly includes: an inflatable airbag 10; an inflator 11 configured to supply gas to the inside of the airbag 10; and a base member 20 configured to store the airbag 10 in a folded state and the inflator 11, and as shown in FIG. 3, the side airbag device S includes: a retainer member 30 adapted to hold from the rear side of the vehicle body the airbag 10 and the inflator 11 that are stored in the base member 20; and a harness 40 connected to the inflator 11 to supply electric power for ignition to the inflator 11. Also, as shown in FIG. 8, the side airbag device S includes: a pad member 50 placed on the vehicle body front side of the base member 20; a cover member 60 adapted to cover the base member 20 and the pad member 50 from the front side of the vehicle body; and a stay cloth 70 having one end sewn to the cover member 60 and the other end locked to stay cloth locking portions 27 of the base member 20, the stay cloth 70 being configured to guide the airbag 10 to inflate.

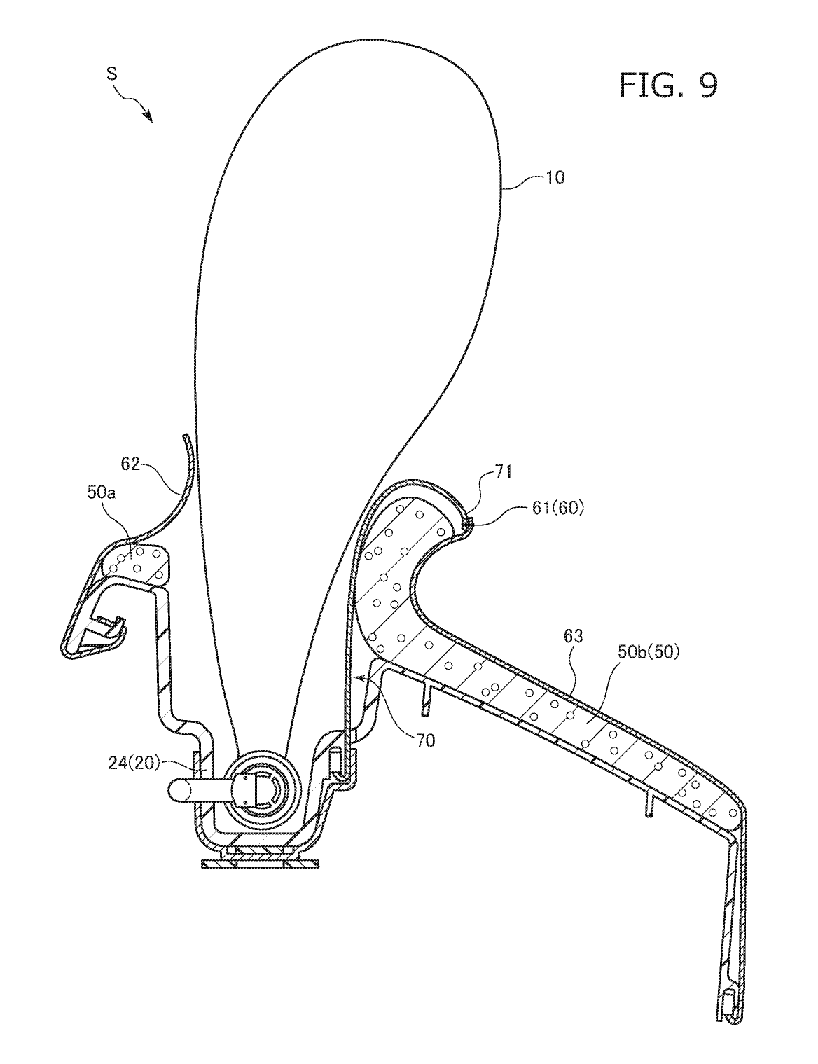

The airbag 10 is configured as a folded member which inflates and deploys from the folded state shown in FIG. 8 toward the front side of the vehicle body into a balloon-like shape as shown in FIG. 9 when an impact is applied from the side of the vehicle body. Specifically, the gas is supplied from the inflator 11, connected to the airbag 10 to serve as a gas generating source, to the inside of the airbag 10; thereby, the airbag 10 is inflated. As shown in FIG. 2, the inflator 11 is configured as a gas generator having an elongated and substantially column-shape and is arranged to be elongated in the up to down direction. The inflator 11 includes: an airbag connecting portion (not shown) protruding beyond the outer surface of the inflator 11 toward the front side of the vehicle body and connected to the inside of the airbag 10; a harness connecting portion 12 formed at an upper end of the inflator 11 and connected to the harness 40; and mounting shafts 13 protruding beyond the outer surface toward the side of the vehicle body and mounted to the base member 20 and the retainer member 30.

In the foregoing configuration, when an impact is applied from the side of the vehicle body, electric power for ignition is supplied from a vehicle battery (not shown), which is arranged on the vehicle body to be located below the foot of a seated occupant, via the harness 40 to the inflator 11; therefore, the airbag 10 is inflated and deployed on the side of the occupant. The airbag 10 and the inflator 11 are stored in an after-mentioned base storage portion 24 provided in the base member 20.

The base member 20 is configured as a resin frame member serving as a base plate of the side airbag device S. As shown in FIG. 2, the base member 20 is configured to store the airbag 10 and the inflator 11. The base member 20, formed as a substantially reversed L-shape when viewed from the side of the vehicle body, is arranged between the seat back la and the vehicle body door 2a in the vehicle body width direction. Upper and lower ends of the base member 20 are detachably attached to respective vehicle body members (not shown). As shown in FIG. 2 and FIG. 3, the base member 20 mainly includes: a base main body 21 arranged between the rear seat 1 and the vehicle body 2; a base outer wall portion 22 and a base inner wall portion 23 that extend continuously from opposite ends of the base main body 21 in the vehicle body width direction toward the rear side of the vehicle body.

The base main body 21, formed as a substantially reversed L-shaped plate member, includes as components: the base storage portion 24 integrally formed to be located slightly closer to the outer side of the vehicle body than the center in the vehicle body width direction and recessed toward the rear side of the vehicle body, an upper base attachment portion 21a and a lower base attachment portion 21b that are attached to the respective vehicle body members (not shown). The lower base attachment portion 21b extends continuously downward from the base main body 21 as shown in FIG. 2 and FIG. 3, and the extending end thereof is attached to the vehicle body member. Specifically, the lower base attachment portion 21b is bent to conform to the shape of the vehicle body located on the rear side of the vehicle body, therefore having a deflected shape. A bolt hole is formed in the extending end of the lower base attachment portion 21b to be opposed to the vehicle body member, and a bolt is tightened and thus the base member 20 is attached to the vehicle body member.

The base outer wall portion 22 is positioned to be opposed to the vehicle body door 2a. Plural locking pawls 22a to which one end of the cover member 60 is locked are formed at an extending end of the base outer wall portion 22 to be placed at intervals in the up to down direction. The base inner wall portion 23 is positioned to be opposed to the seat back 1a. As shown in FIG. 3, a fitting groove 23a into which the other end of the cover member 60 is fitted is formed in an extending end of the base inner wall portion 23 to extend in an elongated shape in the up to down direction.

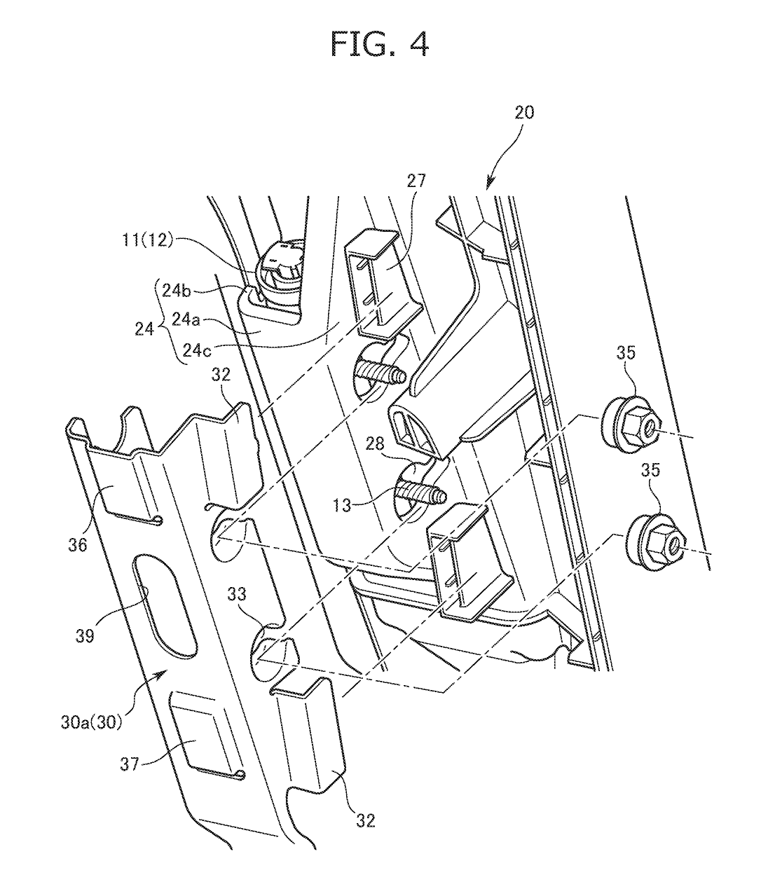

As shown in FIG. 2, the base storage portion 24 is formed as a box-shaped body elongated in the up to down direction and having an opening being open toward the front side of the vehicle body and thus has an inner space having a substantially protruded shape. The airbag 10 and the inflator 11 are detachably stored in the inner space of the base storage portion 24. As shown in FIG. 4, the base storage portion 24 includes: a rear wall portion 24a arranged on the vehicle body rear side of the airbag 10 and the inflator 11; and an outer wall portion 24b and an inner wall portion 24c which extend continuously from opposite ends of the rear wall portion 24a in the vehicle body width direction toward the front side of the vehicle body and which are arranged respectively on the vehicle outer and inner sides in the vehicle body width direction. In addition, an opening is formed in an upper portion of the base storage portion 24 so that the upper end of the inflator 11 is exposed.

As shown in FIG. 3, a cut portion by which a portion of the harness 40 can be supported is provided in the outer wall portion 24b of the base storage portion 24 to be opposed to the harness connecting portion 12 of the inflator 11. As shown in FIG. 4, the inner wall portion 24c has the two stay cloth locking portions 27 which are spaced apart from each other at a predetermined interval in the up to down direction in a protruding manner and to which the other end of the stay cloth 70 can be locked; and two base holes 28 which are spaced apart from each other at a predetermined interval in the up to down direction to be arranged between the two stay cloth locking portions 27 and into which the mounting shafts 13 of the inflator 11 can be inserted.

The retainer member 30 is formed as a metal holding member configured to hold the airbag 10 and the inflator 11 from the rear side of the vehicle body. As shown in FIG. 3, the retainer member 30 is placed onto the base storage portion 24 from the rear side of the vehicle body. The retainer member 30 has a substantially U-shape in transverse cross-section and includes: a rear wall portion 30a arranged on the vehicle body rear side of the base storage portion 24; and an outer wall portion 30b and an inner wall portion 30c that extend continuously from opposite ends of the rear wall portion 30a in the vehicle body width direction toward the front side of the vehicle body.

As shown in FIG. 3, the rear wall portion 30a of the retainer member 30 extends downward from a portion thereof holding the base storage portion 24 toward the lower base attachment portion 21b. The rear wall portion 30a is fixed together with the lower base attachment portion 21b by the bolt to the vehicle body member (not shown) in a state where a portion of the extending downward portion is overlapped with the back surface of the lower base attachment portion 21b. As shown in FIG. 4, the inner wall portion 30c has two stay cloth holding portions 32 which are spaced apart from each other at a predetermined interval in the up to down direction in a protruding manner and which hold the stay cloth locking portions 27 to which the other end of the stay cloth 70 are locked; and two retainer holes 33 which are spaced apart from each other at a predetermined interval in the up to down direction to be arranged between the two stay cloth holding portions 32 and through which the mounting shafts 13 of the inflator 11 can extend. The retainer holes 33 and the base holes 28 are arranged in communication with each other in a state where the retainer member 30 and the base storage portion 24 are attached to each other.

In the foregoing configuration, as shown in FIG. 4, the mounting shafts 13 of the inflator 11 extend through the base holes 28 and the retainer holes 33, and mounting members 35 corresponding to mounting nuts are mounted to insertion ends of the mounting shafts 13 and thereby the inflator 11, the base member 20, and the retainer member 30 are fixed to one another.

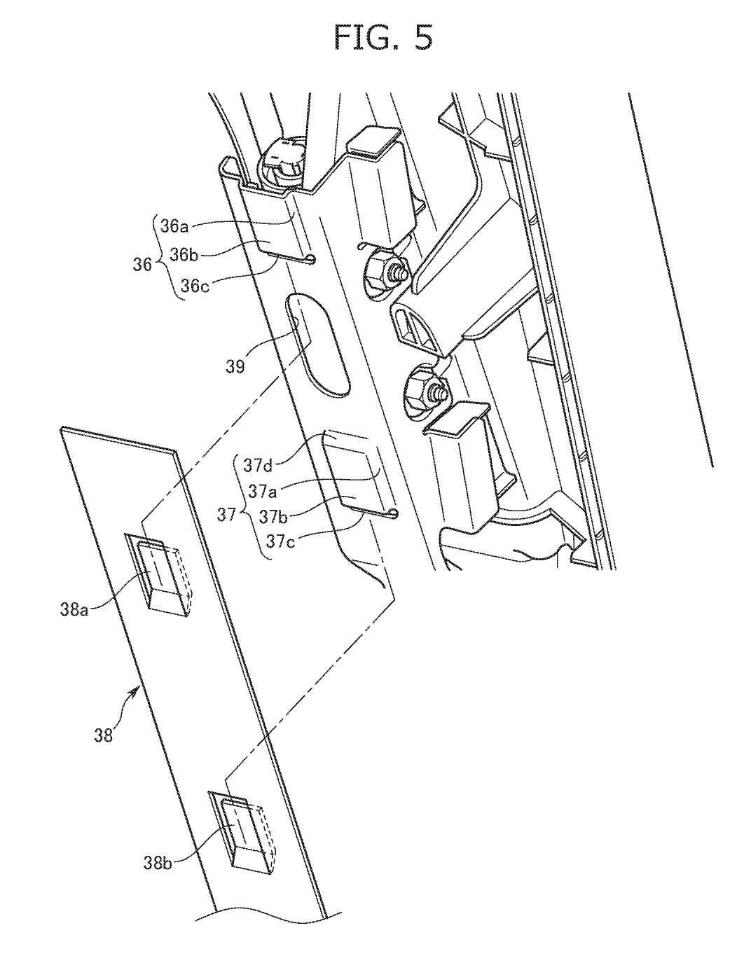

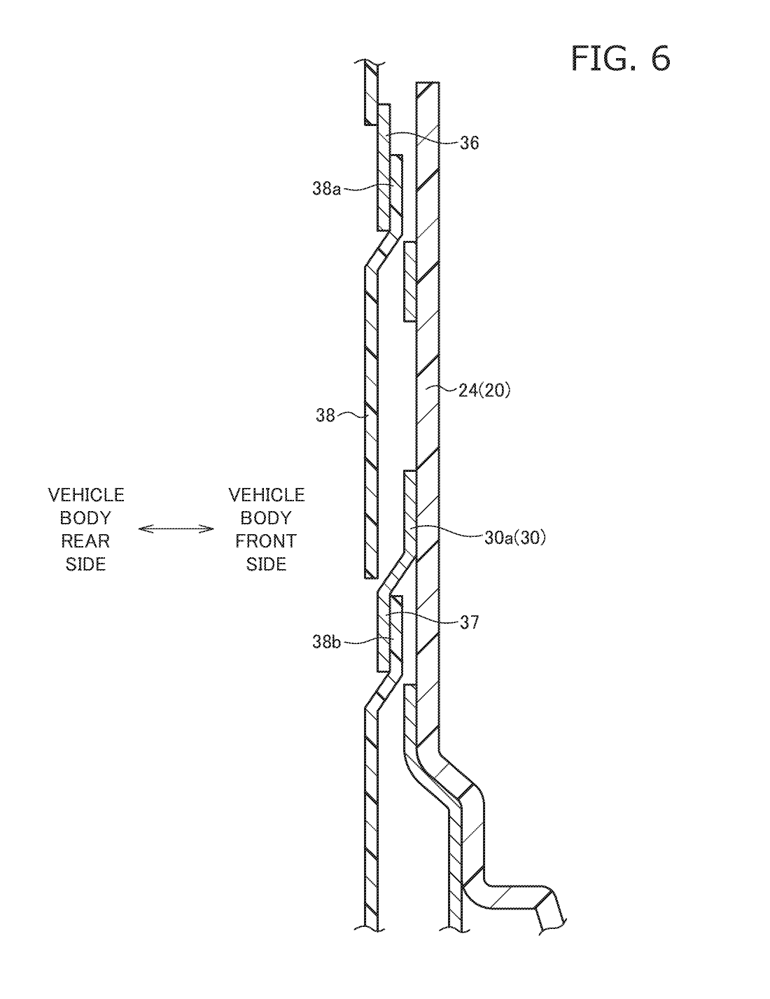

As shown in FIG. 5 and FIG. 6, the rear wall portion 30a is provided at the center in the vehicle body width direction with an upper engagement recessed portion 36 and a lower engagement recessed portion 37. A portion of an upper end of the rear wall portion 30a is cut and raised to form the upper engagement recessed portion 36 protruding toward the rear side of the vehicle body, and a portion of the rear wall portion 30a, which is located below the upper engagement recessed portion 36, is cut and raised to form the lower engagement recessed portion 37 protruding toward the rear side of the vehicle body. The upper engagement recessed portion 36 and the lower engagement recessed portion 37 that protrude toward a vehicle body member 38, located on the vehicle body rear side of the rear wall portion 30a, are respectively positioned to be engaged in the up to down direction with an upper engagement protruded portion 38a and a lower engagement protruded portion 38b that are provided on the vehicle body member 38.

As shown in FIG. 5 and FIG. 6, the upper engagement recessed portion 36 has a substantially rectangular shape and includes: right and left engagement sidewall portions 36a extending continuously from the upper end of the rear wall portion 30a toward the vehicle body member 38; and an engagement rear wall portion 36b connecting extending portions of the right and left engagement sidewall portions 36a. In addition, an engagement opening portion 36c through which the upper engagement protruded portion 38a extends from below into a space surrounded by the right and left engagement sidewall portions 36a and the engagement rear wall portion 36b, is formed in a lower end of the upper engagement recessed portion 36. Likewise, the lower engagement recessed portion 37 has a substantially rectangular shape and includes: right and left engagement sidewall portions 37a; an engagement rear wall portion 37b; and an engagement upper wall portion 37d connected to respective upper ends of the right and left engagement sidewall portions 37a and an upper end of the engagement rear portion 37b. In addition, an engagement opening portion 37c through which the lower engagement protruded portion 38b extends from below into a space surrounded by the right and left engagement sidewall portions 37a, the engagement rear wall portion 37b, and the engagement upper wall portion 37d is formed in a lower end of the lower engagement recessed portion 37.

In the foregoing configuration, as shown in FIG. 5, a through-hole 39 having a substantially elliptical shape is formed in the retainer member 30 to be located in a portion between the upper engagement recessed portion 36 and the lower engagement recessed portion 37 in the up to down direction. Therefore, the weight of the retainer member 30 can be reduced.

Also, in the foregoing configuration, as shown in FIG. 6, when the retainer member 30 is attached to the vehicle body member 38, the upper engagement recessed portion 36 is interposed in contact between a main body of the vehicle body member 38 and the upper engagement protruded portion 38a in the front to back direction of the vehicle body and the lower engagement recessed portion 37 is interposed in contact between the main body of the vehicle body member 38 and the lower engagement protruded portion 38b in the front to back direction of the vehicle body. Therefore, holding force of the retainer member 30 with respect to the vehicle body is increased and thus the vibration of the retainer member 30 can be inhibited. Also, the base member 20 and the retainer member 30 can effectively receive a reaction force generated at the time of inflation and deployment of the airbag 10.

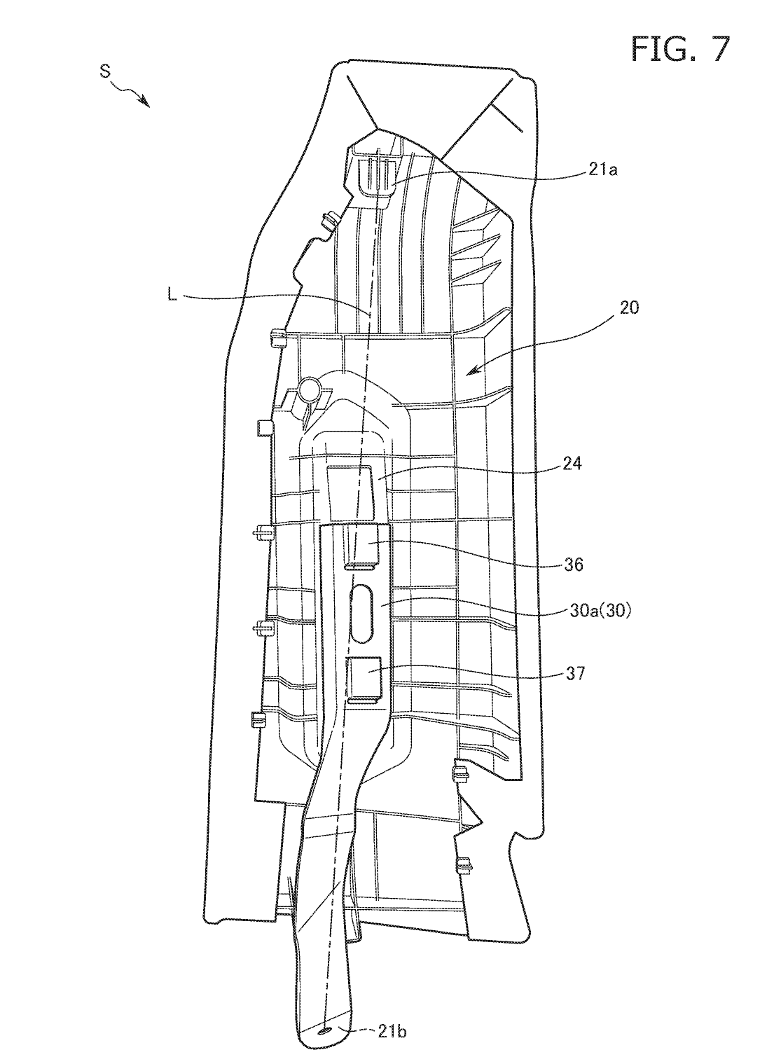

Further, in the foregoing configuration, as shown in FIG. 7, an imaginary surface L passing the upper base attachment portion 21a and the lower base attachment portion 21b for attachment to the vehicle body that are provided on the base member 20 and extending in the front to back direction of the vehicle body passes the upper engagement recessed portion 36 or passes the lower engagement recessed portion 37. Therefore, mounting rigidity of the base storage portion 24 of the base member 20, particularly requiring rigidity in mounting the base member 20 and the retainer member 30 to the vehicle body, can be further improved. As a result, at the time of inflation and deployment of the airbag 10, the base storage portion 24 can have the improved rigidity and the deployment direction of the airbag 10 can be further stabilized.

The harness 40 is a wire harness for supplying electric power for ignition to the inflator 11. Plural electrical wires are bound to be inserted into a corrugated tube and a coupler is attached to an end of the wires; thereby, the harness 40 is formed. As shown in FIG. 3, the harness 40 is configured such that an upper end 41 is connected to the harness connecting portion 12 located at the upper end of the inflator 11 and such that a lower end 42 is connected to the vehicle battery arranged on the vehicle body to be located below the foot of an occupant, and the harness 40 extends to be elongated in the up to down direction.

As shown in FIG. 8, the pad member 50, configured as a cushion material placed between the base member 20 and the cover member 60, is arranged over an entire surface of the base member 20, which faces the front side of the vehicle body. In addition, the pad member 50 is fixed to a pad attachment portion (not shown) provided at the base member 20, thereby being connected to the base member 20. A pad opening portion 51, extending through in the front to back direction of the vehicle body, is formed in a portion of the pad member 50, which is opposed to the base storage portion 24. Specifically, the pad opening portion 51 is formed in a portion of the pad member 50, which is opposed to the outer wall portion 24b of the base storage portion 24.

The pad member 50 integrally includes an outer pad member 50a arranged on the vehicle outer side of the pad opening portion 51 and an inner pad member 50b arranged on the vehicle inner side of the pad opening portion 51. The pad opening portion 51 is an opening elongated in the up to down direction and the stay cloth 70 extends through the pad opening portion 51 from the cover member 60 toward the base member 20. The pad opening portion 51 is located on the opposite side of the stay cloth locking portions 27 from the airbag 10 in the vehicle body width direction.

In the foregoing configuration, when the airbag 10 is inflated and deployed as shown in FIG. 9, the pad member 50 is separated at the pad opening portion 51 as a separating point into the outer pad member 50a and the inner pad member 50b in the vehicle body width direction, so that the airbag 10 is deployed. At this time, the airbag 10 is guided by the stay cloth 70 to inflate; therefore, the airbag 10 can be deployed while a portion of the pad member 50, which is located on the vehicle body front side of the base storage portion 24 does not scatter.

As shown in FIG. 8, the cover member 60 is a cover member adapted to cover the base member 20 and the pad member 50 from the front side of the vehicle body. A cover split-opening portion 61 configured to split-open at the time of inflation and deployment of the airbag 10 is formed in the cover member 60 to be located at a position substantially in the center in the vehicle body width direction, i.e., at the position corresponding to the center of the base storage portion 24. The cover member 60 mainly includes: an outer cover 62 and an inner cover 63 having respective ends connected to each other at the position of the cover split-opening portion 61. The outer cover 62 and the inner cover 63 are arranged respectively on the vehicle outer and inner sides with respect to the cover split-opening portion 61.

The other end of the outer cover 62, which is located on the vehicle outer side is locked to the locking pawls 22a of the base outer wall portion 22 to extend in the up to down direction. The other end of the inner cover 63, which is located on the vehicle inner side is fitted into the fitting groove 23a of the base inner wall portion 23. Specifically, locking holes to be locked to the locking pawls 22a are formed in the other end of the outer cover 62 to extend in the up to down direction. A resin trim strip to be fitted into the fitting groove 23a is sewn to the other end of the inner cover 63.

In the foregoing configuration, when the airbag 10 is inflated and deployed as shown in FIG. 9, the cover member 60 is separated from the cover split-opening portion 61 as a separating point to be deployed into the outer cover 62 and the inner cover 63. The cover split-opening portion 61 is disposed overlapped with the airbag 10 in the vehicle body width direction.

The stay cloth 70 is configured as a cloth member adapted to guide the airbag 10 to be inflated and deployed toward the front side of the vehicle body. As shown in FIG. 8, one end 71 of the stay cloth 70 is attached to the cover split-opening portion 61 of the cover member 60 and the stay cloth 70 extends continuously from the one end 71 to cover the pad member 50, and the other end 72 of the stay cloth 70 is locked to the stay cloth locking portions 27 provided at the base storage portion 24.

Specifically, the stay cloth 70 extends continuously from the one end 71, sewn to the cover split-opening portion 61 at the inner cover 63, toward the vehicle outer side to cover the front surface of the inner pad member 50b and further extends to a portion opposed to the pad opening portion 51. The stay cloth 70 subsequently extends through the pad opening portion 51 and extends continuously along the side surface of the inner pad member 50b, which is located on the vehicle outer side and along the back surface of the inner pad member 50b to a stay cloth insertion hole 29 provided in the inner wall portion 24c of the base storage portion 24.

Then, the stay cloth 70 extends through the stay cloth insertion hole 29 and continuously extends to the stay cloth locking portions 27, thereafter being locked to the stay cloth locking portions 27. In such a case, the resin trim strip to be locked to the stay cloth locking portions 27 is sewn to the other end 72 of the stay cloth 70.

In the foregoing configuration, when the airbag 10 is inflated and deployed as shown in FIG. 9, the stay cloth 70 guides the airbag 10 so that the airbag 10 is inflated toward the cover split-opening portion 61 of the cover member 60. Also, the one end 71 of the stay cloth 70 is deployed together with the inner pad member 50b and the inner cover 63 toward the front side in the front to back direction of the vehicle body and is also deployed toward the vehicle inner side in the vehicle body width direction.

Also, in the foregoing configuration, as shown in FIG. 8, the retainer member 30 holding the airbag 10 and the inflator 11 from the rear side of the vehicle body is supported by the vehicle body member 38 located on the vehicle body rear side of the retainer member 30. Specifically, a portion of the vehicle body member 38 is held in the front to back direction of the vehicle body between the rear wall portion 30a and the upper engagement recessed portion 36 and the lower engagement recessed portion 37 of the retainer member 30. In addition, the upper and lower engagement protruded portions 38a, 38b of the vehicle body member 38 are held in the vehicle body width direction by the upper and lower engagement recessed portions 36, 37 of the retainer member 30. Therefore, the surroundings of the base storage portion 24 can have the improved rigidity at the time of inflation and deployment of the airbag 10 and the inflation and deployment direction of the airbag 10 can be stabilized.

### Other Embodiments

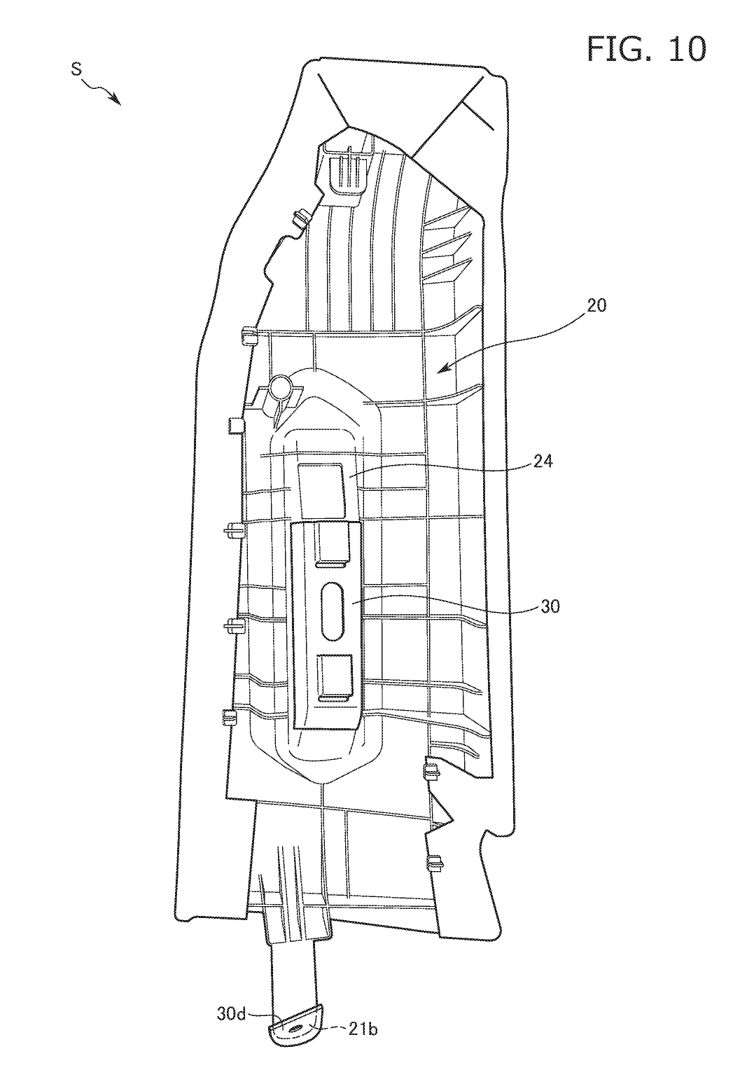

In the foregoing embodiment, as shown in FIG. 10, a halfway portion of the retainer member 30 may be cut so that the length of the retainer member 30 is short in the up to down direction as compared with the length of the retainer member 30 shown in FIG. 3 and so that a portion of the retainer member 30, which is overlapped with the lower base attachment portion 21b is kept as a second retainer piece 30d. Therefore, at least the base storage portion 24 holding the airbag 10 and the inflator 11 is held, and in addition, the weight of the side airbag device S can be reduced. Also, when the lower base attachment portion 21b is attached to a vehicle body member (not shown), the second retainer piece 30d is interposed between the lower base attachment portion 21b and the vehicle body member and thus these can be brought into a metallic contact with one another, therefore improving mounting rigidity.

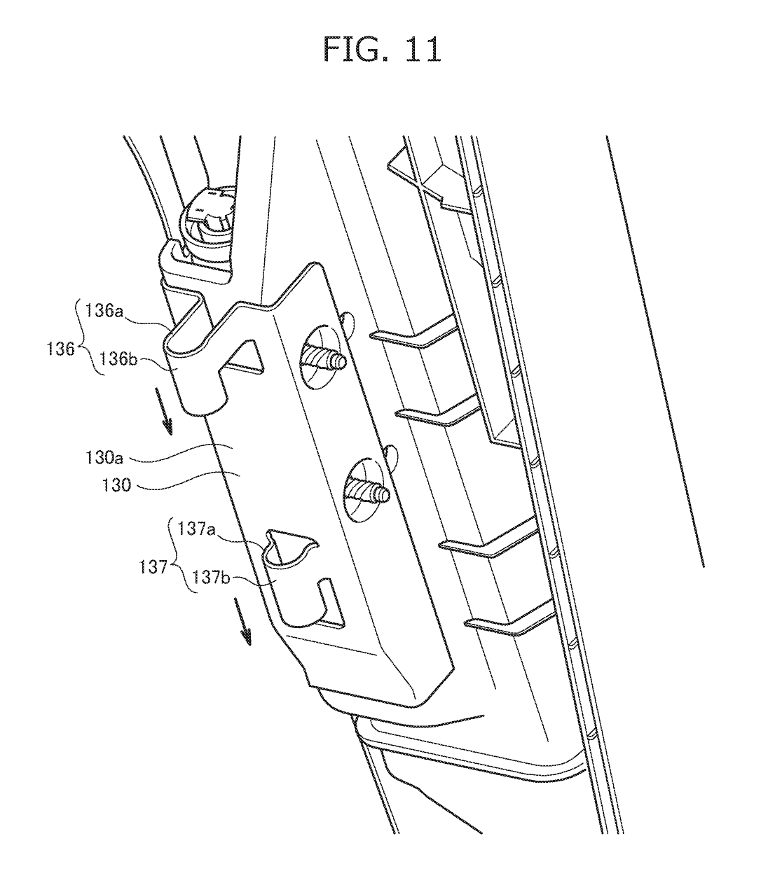

In the foregoing embodiment, the upper engagement recessed portion 36 and the lower engagement recessed portion 37 are formed in the rear wall portion 30a of the retainer member 30 as engagement portions to be engaged with engaged portions provided at portions of the vehicle body. The shape of each of the engagement portions is not especially limited and can be changed. For example, as shown in FIG. 11, portions of a retainer member 130 may be cut and raised to thereby form substantially U-shaped upper and lower engagement protruded portions 136, 137. The upper engagement protruded portion 136 includes: right and left engagement sidewall portions 136a extending continuously from a rear wall portion 130a of the retainer member 130 toward the vehicle body member 38; and an engagement rear wall portion 136b connecting respective extending portions of the right and left engagement sidewall portions 136a and partially protruding downward from the engagement sidewall portions 136a. The lower engagement protruded portion 137 includes: right and left engagement sidewall portions 137a extending continuously from the rear wall portion 130a toward the vehicle body member 38; and an engagement rear wall portion 137b connecting respective extending portions of the right and left engagement sidewall portions 137a and partially protruding downward from the engagement sidewall portions 137a. In addition, the upper and lower engagement protruded portions 136, 137 protrude toward a vehicle body member (not shown) located on the rear side of the vehicle body to be connected in the up to down direction to respective engagement recessed portions (not shown) formed in the vehicle body member. Even in the above configuration, mounting rigidity of the retainer member 130 to the vehicle body member can be improved, and in addition, the work to mount the entire side airbag device S to the vehicle body is facilitated.

In the foregoing embodiment, as shown in FIG. 5, the upper and lower engagement recessed portions 36, 37 (the engagement portions) of the retainer member 30 are engaged with the upper and lower engagement protruded portions 38a, 38b (the engaged portions) of the vehicle body member 38, but are not especially limited thereto. On the other hand, engagement protruded portions may be formed on the retainer member 30 and engagement recessed portions may be formed in the vehicle body member 38.

In the foregoing embodiment, as shown in FIG. 5 and FIG. 6, the upper engagement recessed portion 36 and the lower engagement recessed portion 37 of the retainer member 30 are respectively interposed in contact between the main body of the vehicle body member 38 and the upper engagement protruded portion 38a and between the main body of the vehicle body member 38 and the lower engagement protruded portion 38b in the front to back direction of the vehicle body, but are not especially limited thereto. Alternatively, the upper engagement recessed portion 36 and the lower engagement recessed portion 37 are respectively not necessarily interposed in contact between the main body of the vehicle body member 38 and the upper engagement protruded portion 38a and between the main body of the vehicle body member 38 and the lower engagement protruded portion 38b and may instead be placed at slight intervals therebetween in the front to back direction of the vehicle body.

In the foregoing embodiment, as shown in FIG. 8, the stay cloth locking portions 27 are formed on the inner wall portion 24c of the base storage portion 24, but are not limited thereto. Alternatively, the stay cloth locking portions 27 may be formed on the outer wall portion 24b or the rear wall portion 24a of the base storage portion 24. In addition, the stay cloth locking portions 27 are preferably formed on the base storage portion 24 to be located on the vehicle inner side of the airbag 10 and the inflator 11 in the vehicle body width direction. Thus, the airbag 10 can be more stably inflated and deployed by the stay cloth 70 toward the front side of the vehicle body. The reason for the above is as follows. In the vehicle body width direction with respect to base storage portion 24 storing the airbag 10, a portion of the base storage portion 24, which is located adjacent to the outer wall portion 24b, is supported by the vehicle body door 2a having relatively high rigidity, but a portion of the base storage portion 24, which is located adjacent to the inner wall portion 24c, is supported by the rear seat 1 having relatively high rigidity. In such a case, the airbag 10 is likely to be inflated and deployed while being pulled in the vehicle body width direction toward the rear seat 1 having the high rigidity. Accordingly, the stay cloth locking portions 27 are provided adjacent to the inner wall portion 24c and therefore a portion of the airbag 10 located adjacent to the inner wall portion 24c is preferentially guided by the stay cloth 70. Consequently, the inflation and deployment direction of the airbag 10 is further stabilized.

In the foregoing embodiment, as shown in FIG. 4, the mounting shafts 13 of the inflator 11 are mounted on the inner wall portion 24c of the base storage portion 24, but are not limited thereto. Alternatively, the mounting shafts 13 may be mounted on the outer wall portion 24b or the rear wall portion 24a of the base storage portion 24. In addition, the mounting shafts 13 are preferably mounted on a portion of the base storage portion 24 located adjacent to the inner wall portion 24c in the vehicle body width direction. Thus, mounting rigidity of the portion of the base storage portion 24, which is located adjacent to the inner wall portion 24c is improved; therefore, as described above, the inflation and deployment direction of the airbag 10 is further stabilized.

In the foregoing embodiments, the side airbag device S applied to a rear seat of an automobile is described as a specific example, but other examples are not limited thereto. Alternatively, the side airbag device S may be applied to a front seat for an automobile, a seat for a vehicle such as a train or a bus, or a seat for a conveyance such as an airplane or a boat.

In the foregoing embodiments, the side airbag device S according to the present disclosure is mainly described. It is noted that the embodiments are merely examples for facilitating understanding of the present disclosure and do not limit the present disclosure. It is understood that the present disclosure may be changed or modified without departing from the scope of the present disclosure and that the present disclosure may include its equivalents.

### TABLE OF REFERENCE NUMERALS

S: Side airbag device
1: Rear seat

1a: Seat back
2: Vehicle body

2a: Vehicle body door
10: Airbag
11: Inflator
12: Harness connecting portion
13: Mounting shaft
20: Base member
21: Base main body

21a: Upper base attachment portion

21b: Lower base attachment portion
22: Base outer wall portion

22a: Locking pawl
18 Substitute Specification
23: Base inner wall portion

23a: fitting groove
24: Base storage portion

24a: Rear wall portion

24b: Outer wall portion

24c: Inner wall portion
27: Stay cloth locking portion
28: Base hole
29: Stay cloth insertion hole
30, 130: Retainer member

30a, 130a: Rear wall portion

30b: Outer wall portion

30c: Inner wall portion

30d: Second retainer piece
32: Stay cloth holding portion
33: Retainer hole
35: Mounting member
36: Upper engagement recessed portion (engagement portion)

36a, 37a: Engagement sidewall portion

36b, 37b: Engagement rear wall portion

36c, 37c: Engagement opening portion
37: Lower engagement recessed portion

37d: Engagement upper wall portion
38: Vehicle body member

38a: Upper engagement protruded portion

38b: Lower engagement protruded portion 39: Through-hole
136, 137: Engagement protruded portion (engagement portion)

136a, 137a: Engagement sidewall portion

136b, 137b: Engagement rear wall portion
40: Harness
41: Upper end
42: Lower end
50: Pad member

50a: Outer pad member

50b: Inner pad member
51: Pad opening portion
60: Cover member
61: Cover split-opening portion
62: Outer cover
63: Inner cover
70: Stay cloth
71: One end
72: The other end
L: Imaginary surface

1. A side airbag device provided between a vehicle body and a rear seat, the side airbag device comprising:
an inflatable airbag;
an inflator configured to supply gas to the inside of the airbag;
a base member including a base storage portion configured to store the airbag in a folded state and the inflator, the base member being placed between a vehicle body door and the rear seat; and
a retainer member adapted to hold the base storage portion from a rear side of the vehicle body,
wherein:
upper and lower engagement portions that are spaced apart from each other in an up to down direction and that protrude toward a portion of the vehicle body located on a vehicle body rear side of the retainer member are provided at a center of the retainer member in a vehicle body width direction, the upper and lower engagement portions being engaged with respective engaged portions provided at the portion of the vehicle body.

2. The side airbag device according to claim 1, wherein:
the retainer member includes: a rear wall portion arranged on the vehicle body rear side of the base storage portion, and right and left sidewall portions that extend from opposite ends of the rear wall portion in the vehicle body width direction toward a front side of the vehicle body;
portions of the rear wall portion are cut and raised to form the engagement portions; and
one of an engagement protruded portion and an engagement recessed portion that serve as the engagement portions is engaged in the up to down direction with the other of the engagement protruded portion and the engagement recessed portion that serve as the engaged portions.

3. The side airbag device according to claim 2, wherein:
the base member includes upper and lower base attachment portions positioned so that the base storage portion is interposed between the upper and lower base attachment portions in the up to down direction, the upper and lower base attachment portions being attached to a portion of the vehicle body; and
the upper and lower engagement portions are configured so that an imaginary surface that passes the upper and lower base attachment portions and extends in the front to back direction of the vehicle body passes at least one of the upper and lower engagement portions.

4. The side airbag device according to claim 2, wherein:
each of the engagement portions is the engagement recessed portion, the engagement portion including: right and left engagement sidewall portions that are spaced apart from each other in the vehicle body width direction and extend from the rear wall portion toward the rear side of the vehicle body; and an engagement rear wall portion that connects extending portions of the right and left engagement sidewall portions; and
an engagement opening portion through which the engagement protruded portion extends into a space surrounded by the right and left engagement sidewall portions and the engagement rear wall portion is formed in a lower end of the engagement portion.

5. The side airbag device according to claim 4, wherein:
an engagement upper wall portion that extends from the rear wall portion toward the rear side of the vehicle body and connected to upper ends of the right and left engagement sidewall portions and an upper end of the engagement rear wall portion, is provided at at least one of the upper and lower engagement portions.

6. The side airbag device according to claim 2, wherein:
each of the engagement portions is the engagement protruded portion, the engagement portion including: right and left engagement sidewall portions that are spaced apart from each other in the vehicle body width direction and extend from the rear wall portion toward the rear side of the vehicle body; and an engagement rear wall portion that connects extending portions of the right and left engagement sidewall portions and partially protrudes downward from the engagement sidewall portions; and
the protruding portion of the engagement rear wall portion is engaged with an engagement recessed portion provided in a portion of the vehicle body.

7. The side airbag device according to claim 2, wherein:
respective holes through which a mounting shaft provided on the inflator extends are formed in the base storage portion and the retainer member so as to communicate with each other;
a mounting member is mounted to the mounting shaft from one side of the hole, which is opposite from the other side of the hole, which is located adjacent to the inflator; and
the mounting shaft is mounted on one of the sidewall portions of the retainer member.
